(19) United States
(12) Patent Application Publication
(10) Pub. No.: US 2015/0015933 A1
(43) Pub. Date: Jan. 15, 2015

(54) ELECTROPHORETIC DEVICE, MANUFACTURING METHOD FOR ELECTROPHORETIC DEVICE, AND ELECTRONIC APPARATUS

(71) Applicant: SEIKO EPSON CORPORATION, Tokyo (JP)

(72) Inventors: Tadashi YAMADA, Matsumoto-shi (JP); Hiroki NAKAHARA, Shiojiri-shi (JP)

(21) Appl. No.: 14/325,036

(22) Filed: Jul. 7, 2014

(30) Foreign Application Priority Data
Jul. 10, 2013 (JP) 2013-144264

(51) Int. Cl. G02F 1/167; G02F 1/1341; G02F 1/1339

(52) U.S. Cl. CPC G02F 1/167; G02F 1/1339; G02F 1/1341
USPC 359/296; 156/146; 156/90

(57) ABSTRACT

An electrophoretic device includes: an electrophoretic layer that is disposed between an element substrate and an opposing substrate arranged opposing each other and that includes a dispersion medium in which at least one or more electrophoretic particles are dispersed; a first seal member that is disposed surrounding the electrophoretic layer and bonds the element substrate and the opposing substrate together; and a second seal member that is disposed surrounding the first seal member, bonds the element substrate and the opposing substrate together, and does not include the dispersion medium between the element substrate and the opposing substrate.

### BACKGROUND

1. Technical Field

The present invention relates to electrophoretic devices, manufacturing methods for electrophoretic devices, and electronic apparatuses.

2. Related Art

In the electrophoretic devices, a voltage is applied between pixel electrodes and a common electrode opposing each other with an electrophoretic material therebetween so as to spatially move charged electrophoretic particles such as black particles, white particles, and the like, thereby forming an image in a display region. As an electrophoretic device, for example, such a device configuration is well-known that partitions a spatial area between a pair of substrates into a plurality of spaces by separation walls and confines an electrophoretic dispersion liquid including electrophoretic particles and a dispersion liquid to each of the spaces, as described in JP-A-2010-224240.

Electrophoretic devices have had a problem that electrophoretic particles become slower in motion and consequently the speed of rewriting drops at temperatures below 0° C. (for example, at −30° C.) because the viscosity of a dispersion medium (for example, Isopar) increases at such temperatures. To solve this problem, the inventors have considered using silicone oil as a dispersion medium whose viscosity is suppressed from increasing in a wide temperature range even below 0° C.

However, in the manufacture of an electrophoretic device, in the case where a seal member is formed surrounding a display region on one substrate, silicone oil as a dispersion liquid is injected into a space surrounded by the seal member, and the above space is sealed with the other substrate, an excess of the silicone oil spills over the seal member configured to bond a pair of the substrates together and adheres to a contact area where the seal member makes contact with the other substrate. Alternatively, the silicone oil that passes along the other substrate adheres to a contact portion between the seal member and the other substrate. This raises a problem that the adhesion between the seal member and the other substrate is weakened so that the stated one substrate and the other substrate are likely to be separated from each other.

### SUMMARY

An advantage of some aspects of the invention is to provide electrophoretic devices, manufacturing methods for electrophoretic devices, and electronic apparatuses so as to solve part of the above problem, and the invention can be embodied by the following embodiments or application examples.

### First Application Example

An electrophoretic device according to a first application example includes a first substrate, a second substrate that is disposed opposing the first substrate, an electrophoretic layer having a dispersion medium in which at least one or more electrophoretic particles are dispersed, and a first seal member that is disposed surrounding the electrophoretic layer and bonds the first substrate and the second substrate together. In the stated electrophoretic device, width of the first seal member is no less than 200 μm and no more than 500 μm.

According to this application example, even if an excess of the dispersion medium adheres to an area between the first seal member and the second substrate, it is possible to bond and seal the first substrate and the second substrate together because the width of the first seal member is sufficiently wide to be 200 μm to 500 μm.

### Second Application Example

It is preferable for the electrophoretic device according to the above application example to further include a second seal member that is disposed surrounding the first seal member and bonds the first substrate and the second substrate together, and for the amount of the dispersion medium remaining between the second seal member and the second substrate to be less than the amount of the dispersion medium remaining between the first seal member and the second substrate.

According to this application example, because the first seal member and the second seal member are provided in series on the periphery of the electrophoretic layer, it is possible to increase the bonding strength by using the first seal member for tentative adhesion and forming the second seal member in a region where the dispersion medium has been removed even if an excess of the dispersion medium remains between the first seal member and the second substrate when the first and second substrates are bonded together. Accordingly, it is possible to suppress the first substrate and the second substrate from being separated from each other and to enhance reliability of the sealing.

### Third Application Example

In the electrophoretic device according to the above application example, it is preferable for the electrophoretic layer to be partitioned into a plurality of cells by separation walls disposed in a display region between the first substrate and the second substrate.

According to this application example, because the separation walls are provided in the display region of the electrophoretic layer sandwiched between the first and second substrates so as to partition the electrophoretic layer into the plurality of cells, it is possible to determine a cell gap between the first and second substrates based on the height of the separation walls.

### Fourth Application Example

In the electrophoretic device according to the above application example, it is preferable for a frame separation wall to be disposed surrounding the electrophoretic layer between the electrophoretic layer and the first seal member.

According to this application example, because the frame separation wall is provided between the electrophoretic layer and the first seal member, it is possible to prevent the dispersion medium from flowing out with the frame separation wall when the dispersion medium is supplied into the display region. This makes it possible to hold the dispersion medium between the first and second substrates. In addition, because the frame separation wall is provided at the outside of the display region in which the electrophoretic layer is provided, it is also possible to prevent the first seal member from penetrating into the display region.

### Fifth Application Example

In the electrophoretic device according to the above application example, it is preferable for the frame separation wall to be disposed in contact with the first seal member.

According to this application example, because the frame separation wall is provided in contact with the inside of the first seal member, the first seal member can be prevented from spreading into the display region. Further, it is possible to regulate the width of the first seal member to be within a predetermined width. With this, it is possible to ensure strength of the first seal member and to suppress generation of a gap among the first and second substrates, the frame separation wall, and the first seal member, thereby making it possible to prevent air bubbles, moisture, or the like from entering between the first substrate and the second substrate.

### Sixth Application Example

In the electrophoretic device according to the above application example, it is preferable for height of the frame separation wall to be 10 μm to 50 μm, and for a distance from the display region to respective end surfaces of the first substrate and the second substrate to be equal to or less than 1 mm.

According to this application example, causing the height of the frame separation wall to be 10 μm to 50 μm makes it possible for the first seal member to have the predetermined width; in addition, the distance from the display region to the end surfaces of the substrates is equal to or less than 1 mm. Accordingly, it is possible to provide a miniaturized electrophoretic device.

### Seventh Application Example

In the electrophoretic device according to the above application example, it is preferable for the separation walls and the frame separation wall to be made of the same material.

According to this application example, because the separation walls and the frame separation wall are configured with the same material, they can be manufactured in the same process and consequently can be efficiently manufactured.

### Eighth Application Example

In the electrophoretic device according to the above application example, it is preferable for the aforementioned dispersion medium to be silicone oil.

According to this application example, using the silicone oil makes it possible to cause electrophoretic particles included in the electrophoretic layer to operate even at low temperatures (for example, at approximately −30° C.), thereby making it possible to suppress the switching speed thereof from being decreased.

### Ninth Application Example

In the electrophoretic device according to the above application example, it is preferable for the viscosity of the dispersion medium to be equal to or less than 10 cP.

According to this application example, as described above, due to the narrow gap being 10 μm to 50 μm and due to the silicone oil being a low-viscosity solvent, the electrophoretic particles can migrate between the electrodes in equal to or less than 500 ms, for example, even at a low temperature of −30° C., for example.

### Tenth Application Example

In the electrophoretic device according to the above application example, it is preferable for the electrophoretic particles to include white particles and black particles, for a weight percentage of the white particles to the total weight of the white particles, the black particles, and the dispersion medium to be equal to or less than 30%, and for a weight percentage of the black particles to the above total weight to be equal to or less than 10%.

According to this application example, with the above weight percentages of the particles, a reflection rate is made to be equal to or more than 40% and a black-color reflection rate is made to be equal to or less than 2%, thereby making it possible to enhance display performance.

### Eleventh Application Example

In the electrophoretic device according to the above application example, it is preferable for a sealing film to be provided between the electrophoretic layer and the second substrate and between the separation walls and the second substrate.

According to this application example, because a sealing film is provided at least between the separation walls and the second substrate, a tip portion of each of the separation walls can penetrate into the sealing film, thereby making it possible to prevent the dispersion medium from flowing into or flowing out between adjacent cells.

### Twelfth Application Example

A manufacturing method for an electrophoretic device according to a twelfth application example includes applying a first seal member on the periphery of a display region on a first substrate, supplying the display region with a dispersion medium including electrophoretic particles, and bonding the first substrate to a second substrate that is disposed opposing the first substrate with the first seal member therebetween under a lower pressure than atmospheric pressure so that a width of the first seal member is no less than 200 μm and no more than 500 μm after the bonding.

According to this application example, even if an excess of the dispersion medium adheres to an area between the first seal member and the second substrate, the first substrate and the second substrate can be bonded and sealed because the width of the first seal member is sufficiently wide to be 200 μm to 500 μm.

### Thirteenth Application Example

It is preferable for the manufacturing method for the electrophoretic device according to the above application example to further include: removing at least the dispersion medium adhering to regions that each make contact with a second seal member to be formed on the periphery of the first seal member; and forming the second seal member on the periphery of the first seal member.

According to this application example, a cleaning process is performed on the regions that each make contact with the second seal member (first substrate, second substrate, first seal member); therefore, even if an excess of the dispersion medium to be sealed spills over the first seal member when the first and second substrates are bonded together, strength of the second seal member for bonding the first and second substrates together can be enhanced because the excess of the dispersion substrate that spills over the first seal member is removed through the cleaning process. As a result, it is possible to suppress the first substrate and the second substrate from being separated from each other.

### Fourteenth Application Example

It is preferable for the manufacturing method for the electrophoretic device according to the above application example to furthermore include forming separation walls for defining a plurality of cells in the display region on the first substrate before the applying of the first seal member.

According to this application example, because the separation walls are formed in the display region, it is possible to determine a cell gap between the first and second substrates based on the height of the separation walls when the first and second substrates are bonded together.

### Fifteenth Application Example

It is preferable for the manufacturing method for the electrophoretic device according to the above application example to still further include forming a frame separation wall surrounding the display region on the first substrate before the applying of the first seal member.

According to this application example, because the frame separation wall is formed surrounding the display region, it is possible to prevent the dispersion medium from flowing out with the frame separation wall when the dispersion medium is supplied into the display region. This makes it possible to hold the dispersion medium between the first and second substrates. In addition, because the frame separation wall is provided at the outside of the display region in which the electrophoretic layer is provided, it is also possible to prevent the first seal member, which is formed later, from penetrating (spreading) into the display region.

### Sixteenth Application Example

In the manufacturing method for the electrophoretic device according to the above application example, it is preferable for viscosity of the first seal member to be 300 thousand Pa·s to 1 million Pa·s, and for viscosity of the second seal member to be 100 Pa·s to 500 Pa·s.

According to this application example, using the first seal member in the above viscosity range makes it possible to push out the dispersion medium having entered between the first seal member and the second substrate. Further, using the second seal member in the above viscosity range makes it possible for the second seal member to be inserted into a location on the periphery of the first seal member between the first substrate and the second substrate, whereby the bonding strength of the second seal member can be enhanced. In addition, it is possible to prevent moisture from entering into the interior from the exterior through the second seal member and the first seal member so as to obtain a highly reliable sealing structure.

### Seventeenth Application Example

In the manufacturing method for the electrophoretic device according to the above application example, it is preferable for the dispersion medium to be silicone oil.

According to this application example, because the surfaces of molecules of silicone oil are covered with a methyl group, the surface energy and the cohesion thereof are low, whereby the bonding strength of the seal member is weakened. However, because the silicon oil, having high wettability, is not interposed in a portion that makes contact with the second seal member, the strength of the second seal member can be enhanced, thereby making it possible to enhance reliability of the sealing.

### Eighteenth Application Example

An electronic apparatus according to an eighteenth application example includes the electrophoretic device according to above application examples.

According to this application example, it is possible to provide an electronic apparatus with enhanced reliability of the sealing because the apparatus includes the electrophoretic device discussed above.

### BRIEF DESCRIPTION OF THE DRAWINGS

The invention will be described with reference to the accompanying drawings, wherein like numbers reference like elements.

FIG. 1 is a perspective view of an electronic apparatus equipped with an electrophoretic device.

FIG. 2 is an equivalent circuit diagram illustrating an electrical configuration of an electrophoretic device.

FIG. 3 is a schematic plan view illustrating a structure of an electrophoretic device.

FIG. 4 is a schematic cross-sectional view of the electrophoretic device taken along a IV-IV line in FIG. 3.

FIG. 5 is a schematic plan view illustrating an electrophoretic device mainly focusing on a structure of a seal member and its periphery.

FIG. 6 is a schematic cross-sectional view illustrating the electrophoretic device taken along a VI-VI line in FIG. 5.

FIG. 7 is a flowchart illustrating a manufacturing method for an electrophoretic device in the order of processes to be carried out.

FIGS. 8A through 8C are schematic cross-sectional views illustrating a part of a manufacturing method for an electrophoretic device.

FIGS. 9D through 9F are schematic cross-sectional views illustrating another part of the manufacturing method for the electrophoretic device.

FIGS. 10G through 101 are schematic cross-sectional views illustrating a still another part of the manufacturing method for the electrophoretic device.

FIG. 11 is a cross-sectional view illustrating a configuration of a variation on an electrophoretic device.

FIG. 12 is a cross-sectional view illustrating a configuration of another variation on the electrophoretic device.

FIG. 13 is a cross-sectional view illustrating a configuration of still another variation on the electrophoretic device.

FIG. 14 is a cross-sectional view illustrating a configuration of still another variation on the electrophoretic device.

### DESCRIPTION OF EXEMPLARY EMBODIMENTS

Hereinafter, specific embodiments of the invention will be described based on the drawings. Note that the drawings used here illustrate the areas being described in an enlarged or reduced manner so that those areas can be recognized properly.

Note also that in the following embodiments, the phrase “on a substrate”, for example, can refer to a constituent element being disposed directly on top of the substrate, a constituent element being disposed on top of the substrate with another constituent element provided therebetween, or part of the constituent element being disposed directly on top of the substrate while another part is disposed on top of the substrate with another constituent element provided therebetween.

### Configuration of Electronic Apparatus

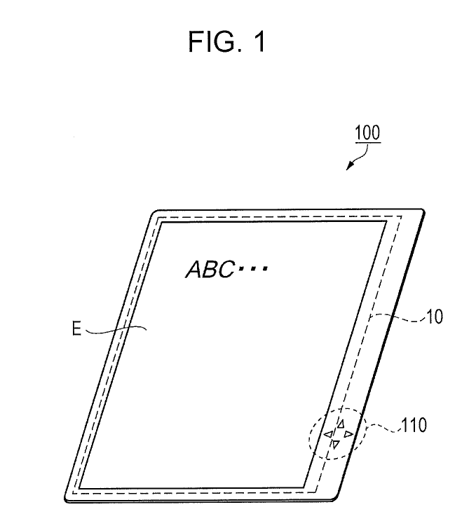

FIG. 1 is a perspective view of an electronic apparatus equipped with an electrophoretic device. Hereinafter, the configuration of an electronic apparatus will be described with reference to FIG. 1.

As shown in FIG. 1, an electronic apparatus 100 includes an electrophoretic device 10 and an interface for operation of the electronic apparatus 100. More specifically, the interface refers to an operation section 110 configured of switches and the like.

The electrophoretic device 10 is a display module having a display region E. The display region E is formed of a plurality of pixels that are electrically controlled so as to display an image in the display region E.

In order to provide electronic apparatuses including the electrophoretic device 10, the invention may be applied to electronic paper displays (EPDs), watches, wristable apparatuses, and so on.

### Electrical Configuration of Electrophoretic Device

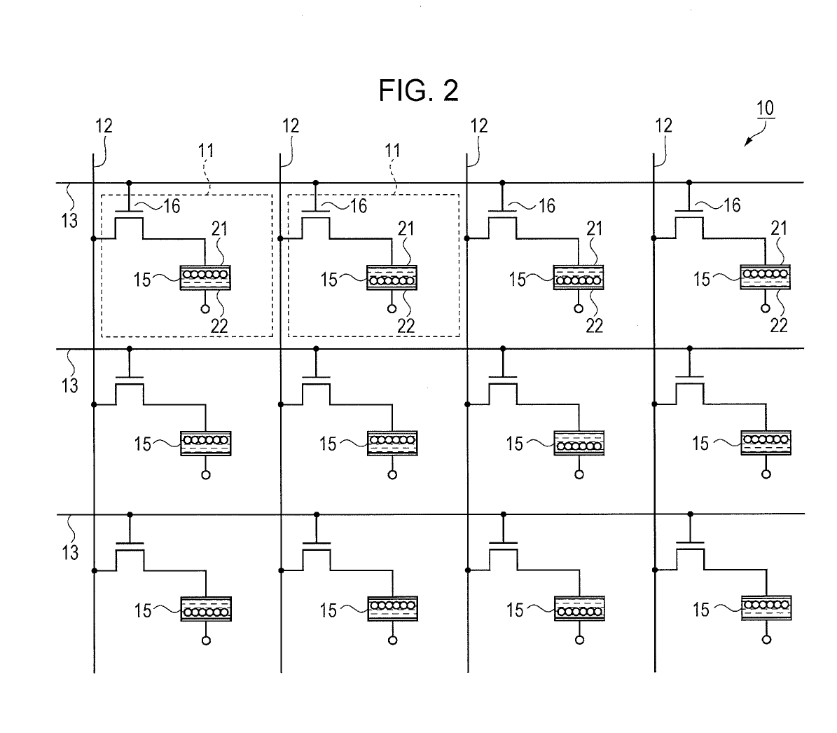

FIG. 2 is an equivalent circuit diagram illustrating an electrical configuration of the electrophoretic device. Hereinafter, the electrical configuration of the electrophoretic device will be described with reference to FIG. 2.

As shown in FIG. 2, the electrophoretic device 10 includes a plurality of data lines 12 and a plurality of scanning lines 13; a pixel 11 is disposed in a portion where the data lines 12 and the scanning lines 13 intersect with each other. To be more specific, the electrophoretic device 10 includes a plurality of pixels 11 disposed in matrix form along the data lines 12 and the scanning lines 13. Each pixel 11 includes a dispersion medium 15 containing electrophoretic particles disposed between a pixel electrode 21 and a common electrode 22.

The pixel electrode 21 is connected with the data line 12 via a transistor 16 (TFT 16). A gate electrode of the TFT 16 is connected with the scanning line 13. Note that FIG. 2 illustrates an example of the configuration, and other elements such as a holding capacitor or the like may be integrated therein as needed.

### Structure of Electrophoretic Device

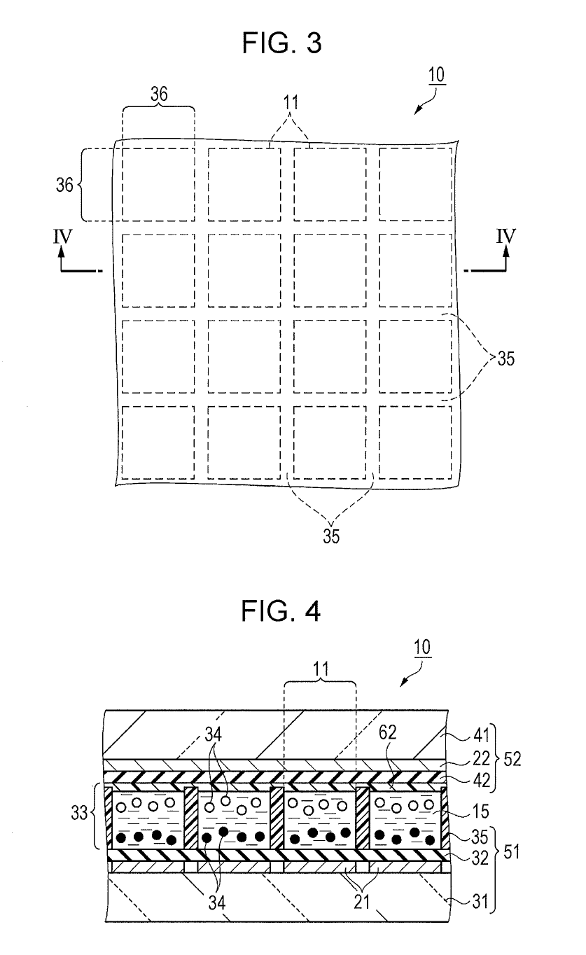

FIG. 3 is a schematic plan view illustrating a structure of the electrophoretic device. FIG. 4 is a schematic cross-sectional view of the electrophoretic device taken along a IV-IV line in FIG. 3. Hereinafter, the structure of the electrophoretic device will be described with reference to FIGS. 3 and 4.

As shown in FIGS. 3 and 4, the electrophoretic device 10 includes an element substrate 51 as a first substrate, an opposing substrate 52 as a second substrate, and an electrophoretic layer 33. The pixel electrode 21 is disposed for each of the pixels 11 on a first substrate member 31 that constitutes the element substrate 51 and is formed of, for example, a light-transmissive glass substrate.

More specifically, as shown in FIGS. 3 and 4, the pixels 11 (pixel electrodes 21) are formed in a matrix, for example, when viewed from above. As a material of the pixel electrodes 21, a light transmitting material such as ITO (Indium Tin Oxide: indium oxide in which tin is added) or the like is used, for example.

Between the first substrate member 31 and the pixel electrodes 21, there is provided a circuit section (not shown) in which the TFTs 16 and the like are formed. The TFTs 16 are electrically connected with the respective pixel electrodes 21 via contact portions (not shown). Although not illustrated, aside from the TFTs 16, various types of wiring (for example, the data lines 12, scanning lines 13, and so on), electric elements (for example, holding capacitors), and the like are also disposed in the circuit section. A first insulation layer 32 is formed across a surface on the first substrate member 31 as well as the pixel electrodes 21. Such a structure may be employed that does not include the first insulation layer 32.

The common electrode 22 (configured with a single solid pattern) shared by the plurality of pixels 11 is formed on a second substrate member 41 that constitutes the opposing substrate 52, and is made of, for example, a light-transmissive glass substrate. A light transmitting material such as ITO or the like is used for the common electrode 22. A second insulation layer 42 is formed across a surface on the common electrode 22. Such a structure may be employed that does not include the second insulation layer 42.

The electrophoretic layer 33 is provided between the first insulation layer 32 and the second insulation layer 42. The dispersion medium 15 which constitutes the electrophoretic layer 33 and in which at least one or more electrophoretic particles are dispersed fills each space defined by the first insulation layer 32, the second insulation layer 42, and separation walls (ribs) 35 disposed on the first substrate member 31. As shown in FIG. 3, the separation walls 35 are formed in a grid pattern as a whole. It is preferable for the separation wall 35 to be made of a light-transmissive material (such as acryl or epoxy resin). Thickness of the separation wall 35 is, for example, 5 μm. In this embodiment, although the pixel electrodes 21 are respectively disposed for each of the pixels 11 and the separation walls (ribs) 35 are disposed for each of the pixel electrodes 21, the invention is not intended to be limited thereto; the separation walls (ribs) may be formed for each group of multiple pixels, for example, for every 2 to 20 pixels.

When the element substrate 51 is bonded to the opposing substrate 52, an upper portion of the separation wall 35 makes contact with the opposing substrate 52 (specifically, a sealing film 62). Accordingly, it is possible to determine a cell gap between the element substrate 51 and the opposing substrate 52 based on the height of the separation walls 35.

In FIG. 4, white particles and black particles are illustrated as electrophoretic particles 34. For example, in the case where a voltage is applied between the pixel electrode 21 and the common electrode 22, the electrophoretic particles 34 make electrophoretic movement toward one of the electrodes (pixel electrode 21, common electrode 22) following an electric field generated therebetween. For example, in the case where the white particles are positively charged, if the pixel electrode 21 is made to be at a negative potential, the white particles move and gather at the pixel electrode 21 side (lower side) to give dark display.

On the other hand, if the pixel electrode 21 is made to be at a positive potential, the white particles move and gather at the common electrode 22 side (upper side) to give white display. In this manner, desired information (image) is displayed in accordance with presence/absence, the number, or the like of the white particles that gather at the electrode of the display side. The white particles and black particles are used here as the electrophoretic particles 34; however, particles of other colors may also be used.

As the electrophoretic particles 34, inorganic pigment-based particles, organic pigment-based particles, polymeric microparticles, or the like can be used; two or more types of particles may be mixed and used. The electrophoretic particles 34 with the diameter being approximately 0.05 μm to 10 μm are used, preferably the particles with the diameter being 0.2 μm to 2 μm are used, for example.

The contained amount of the white particles is equal to or less than 30% in terms of weight in the total weight of the dispersion medium 15, the white particles, and the black particles, while the contained amount of the black particles is equal to or less than 10% in terms of weight in the total weight of the dispersion medium 15, the white particles, and the black particles. With these content rates, a reflection rate is made to be equal to or more than 40% and a black-color reflection rate is made to be equal to or less than 2%, thereby making it possible to enhance display performance.

As the dispersion medium 15, silicone oil in which the electrophoretic particles 34 are capable of moving even at a temperature of approximately −30° C. is used in this embodiment. However, because the surfaces of molecules of silicone oil are covered with a methyl group, the surface energy and the cohesion thereof are low so that the silicone oil can considerably weaken the bonding strength of a seal member 14 by adhering to the seal member 14. The viscosity of silicone oil is, for example, equal to or less than 10 cP. Since the silicone oil is a low-viscosity solvent, the electrophoretic particles can migrate between the electrodes in equal to or less than 500 ms even at a low temperature of approximately −30° C., for example.

Note that in the following description, regions enclosed by the separation walls 35 are each referred to as a cell 36. Each of the cells 36 includes the pixel electrode 21, the common electrode 22, and the electrophoretic layer 33.

### Structure of Seal Member and Periphery Thereof

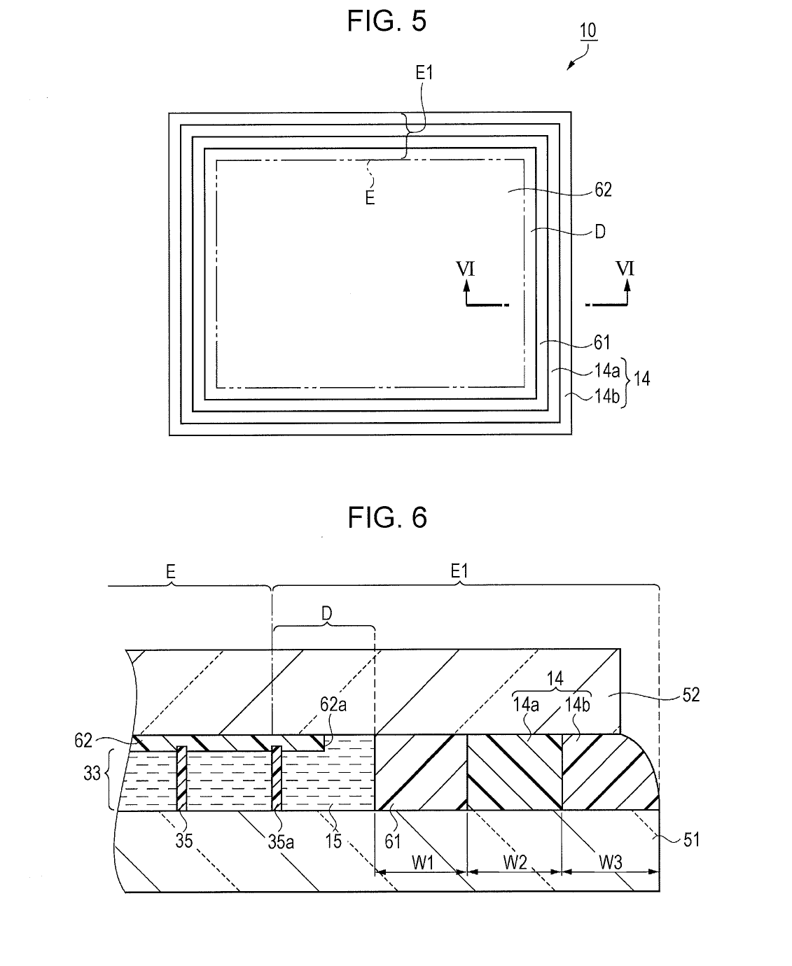

FIG. 5 is a schematic plan view illustrating the electrophoretic device mainly focusing on a structure of a seal member and its periphery. FIG. 6 is a schematic cross-sectional view illustrating the electrophoretic device taken along a VI-VI line in FIG. 5. Hereinafter, of the electrophoretic device, the structure of the seal member and its periphery will be mainly described with reference to FIGS. 5 and 6. Note that the insulation layers, the wiring, the electrodes, and the like are omitted in the drawings.

As shown in FIGS. 5 and 6, the electrophoretic device 10 includes a frame region E1 surrounding the display region E. The frame region E1 includes a dummy region D corresponding to a region of the electrophoretic layer 33 that does not contribute to display, a frame separation wall 61 disposed outside the dummy region D, and the seal member 14 disposed outside the frame separation wall 61. Width of the frame region E1 is, for example, approximately 1 mm.

Width of the dummy region D is approximately 30 μm, for example. At the display region E side of the dummy region D, there is provided a separation wall 35a similar to the separation wall 35. The frame separation wall 61 is provided outside the dummy region D. The frame separation wall 61 is disposed surrounding the dummy region D, and is used to prevent the dispersion medium 15 from flowing out to the exterior and to adjust the cell gap. The frame separation wall 61 is configured with the same material as that of the separation wall 35 in the display region E.

A width W1 of the frame separation wall 61 is, for example, 150 μm. Thickness of the frame separation wall 61 is in a range of 10 μm to 50 μm, for example; the thickness thereof is 30 μm in this case. The frame separation wall 61 is also used to prevent a first seal member 14a that is disposed adjacent thereto from extending into the display region E.

The seal member 14 includes the first seal member 14a and a second seal member 14b. The first seal member 14a is provided surrounding the frame separation wall 61, and is used for bonding and sealing of the element substrate 51 and the opposing substrate 52 together. A width W2 of the first seal member 14a is, for example, 400 μm. Viscosity of the first seal member 14a is, for example, 300 thousand Pa·s to 1 million Pa·s; it is preferable for the viscosity thereof to be approximately 400 thousand Pa·s. Using the first seal member 14a having such viscosity makes it possible to ensure contact areas with the element substrate 51 and the opposing substrate 52.

The second seal member 14b is disposed surrounding the first seal member 14a, and is used to bond the element substrate 51 to the opposing substrate 52. A width W3 of the second seal member 14b is, for example, 400 μm. Viscosity of the second seal member 14b is, for example, 100 Pa·s to 500 Pa·s; it is preferable for the viscosity thereof to be approximately 400 Pa·s. Using the second seal member 14b having such viscosity makes it possible for the second seal member 14b to be inserted into a location on the periphery of the first seal member 14a between the element substrate 51 and the opposing substrate 52, whereby the bonding strength of the second seal member 14b can be enhanced.

It is also possible to prevent moisture from entering into the interior of the device from the exterior through the second seal member 14b and the first seal member 14a, whereby a sealing structure having high reliability can be obtained.

Note that the frame separation wall 61, the widely-formed first seal member 14a, and also the widely-formed second seal member 14b are provided in series on the periphery of the electrophoretic layer 33. Accordingly, even if the dispersion medium 15 to be sealed spills over the frame separation wall 61, the first seal member 14a, and the like when the element substrate 51 and the opposing substrate 52 are bonded together, the two substrates are bonded and sealed by the first seal member 14a and further the bonding strength can be enhanced by the second seal member 14b. With this, the element substrate 51 and the opposing substrate 52 can be suppressed from being separated from each other, thereby making it possible to enhance the reliability of the sealing.

Between the upper portion of the separation walls 35 and the opposing substrate 52 in the display region E, there is provided the sealing film 62 configured to prevent the dispersion medium 15 from flowing into or flowing out between the cells 36 adjacent to each other. To be more specific, the material of the sealing film 62 is configured with, for example, a urethane-based material, a transparent resin such as polyvinyl alcohol, or synthetic rubber such as nitrile rubber. The upper portion of the separation wall 35 penetrates into the sealing film 62.

It is preferable for thickness of the sealing film 62 to be such that the film will not interfere with the electric field; therefore, the thickness of the sealing film 62 is, for example, approximately 2 μm to 6μm. The penetration amount of the separation wall 35 into the sealing film 62 is approximately 0.5 μm to 1 μm, for example. Note that the sealing film 62 is weak in interfacial strength (peel strength). This can cause separation of the seal member 14 (first seal member 14a, second seal member 14b); therefore the sealing film 62 and the seal member 14 are disposed so as not to overlap with each other when viewed from above.

An end portion 62a of the sealing film 62 is arranged between the separation wall 35a located on the outmost circumference of the display region E and the frame separation wall 61, that is, arranged within a range of the dummy region D, for example. The sealing film 62 is a size larger than the display region E, that is, the size of the sealing film 62 is such that the end portion 62a will not penetrate into the display region E even if there is variation in the size thereof. Hereinafter, a manufacturing method for the electrophoretic device 10 will be described.

### Manufacturing Method for Electrophoretic Device

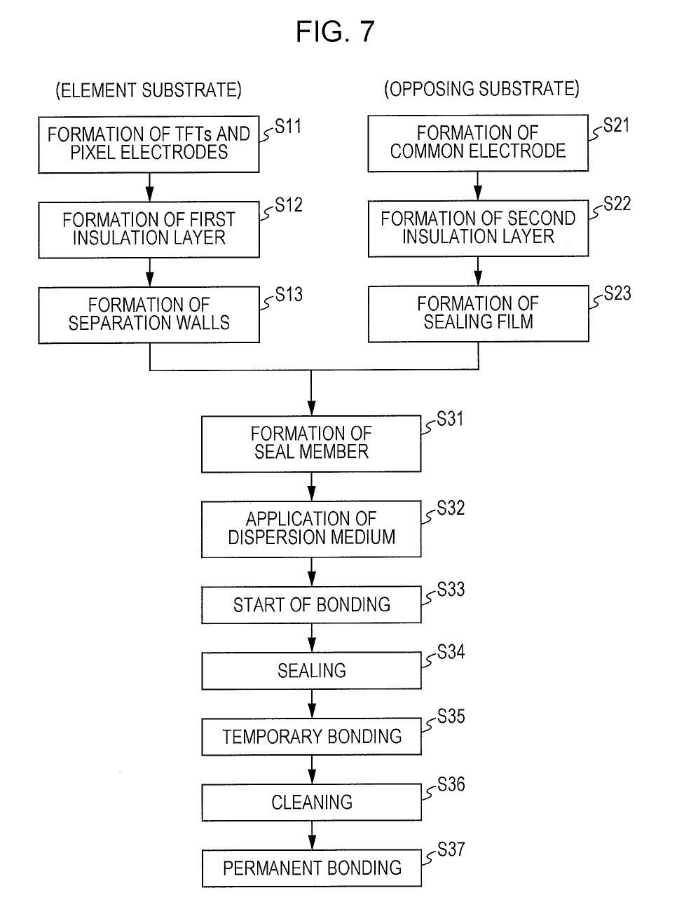

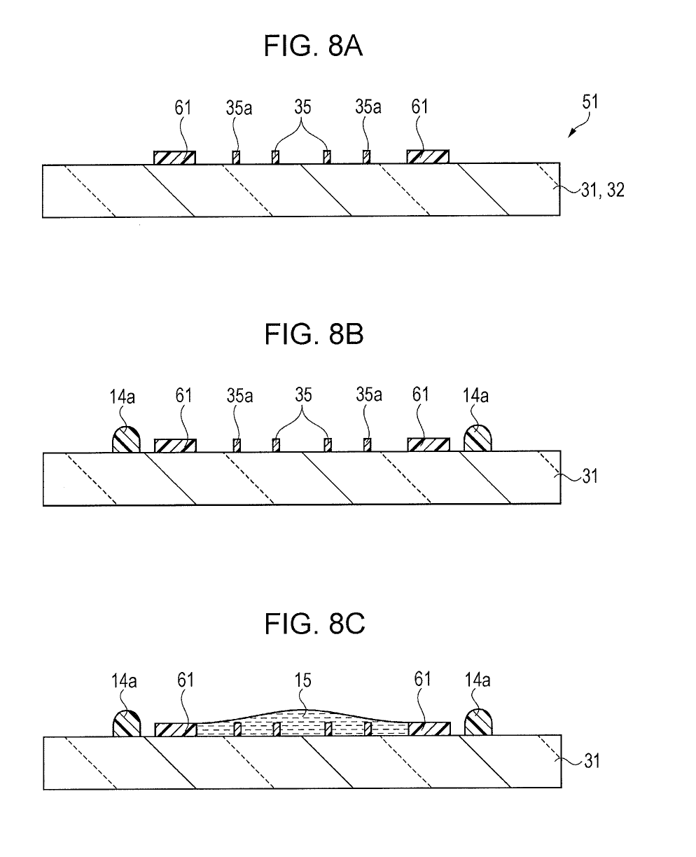

FIG. 7 is a flowchart illustrating a manufacturing method for the electrophoretic device in the order of processes to be carried out. FIGS. 8A through 10I are schematic cross-sectional views illustrating part of the manufacturing method for the electrophoretic device. Hereinafter, the manufacturing method for the electrophoretic device will be described with reference to FIG. 7 through FIG. 10I.

First, referring to FIG. 7, the manufacturing method for the element substrate 51 will be explained. In step S11, the TFTs 16, the pixel electrodes 21 made of a light transmitting material such as ITO, and the like are formed on the first substrate member 31 made of a light-transmissive material such as glass or the like. Specifically, the TFTs 16, the pixel electrodes 21, and the like are formed using a known deposition technique, a known photolithography technique, and a known etching technique. Note that in the following description using the cross-sectional views, the TFTs 16, the pixel electrodes 21, and the like are not discussed and not illustrated.

In step S12, the first insulation layer 32 is formed on the first substrate member 31. As a manufacturing method of the first insulation layer 32, such a method can be cited that an insulation material is applied on the first substrate member 31 using a spin coat method or the like, thereafter the applied insulation material is dried so as to form the first insulation layer 32, for example.

In step S13, as shown in FIG. 8A, the separation walls 35 are formed on the first substrate member 31 (specifically, on the first insulation layer 32). To be more specific, the separation walls 35 in the display region E, the separation wall 35a at the outmost circumference of the display region E, and the frame separation wall 61 disposed on the outside of the separation wall 35a are concurrently formed. The separation walls 35, 35a, and the frame separation wall 61 can be formed using a known deposition technique, a known photolithography technique, and a known etching technique.

As described above, the separation walls 35, 35a, and the frame separation wall 61 are formed concurrently using the same material, which makes it possible to efficiently manufacture the substrate. Through this, the element substrate 51 is completed.

The separation walls 35 are formed of a material that is not dissolved in the dispersion medium 15. It does not matter whether the stated material is organic or inorganic. More specifically, as examples of the organic material, the following can be cited: that is, urethane resin, urea resin, acyl resin, polyester resin, silicone resin, acryl silicone resin, epoxy resin, polystyrene resin, styrene acryl resin, polyolefin resin, butyral resin, vinylidene chloride resin, melamine resin, phenol resin, fluorine resin, polycarbonate resin, poly-sulfone resin, polyether resin, polyamide resin, polyimide resin, and so on. A single resin among these resins or a composite material of two or more of these resins is used.

Next, a manufacturing method for the opposing substrate 52 will be explained. In step S21, the common electrode 22 is formed on the second substrate member 41. More specifically, the common electrode 22 is formed across a surface on the second substrate member 41 made of a light-transmissive material such as a glass substrate or the like, by using a known deposition technique.

In step S22, the second insulation layer 42 is formed on the common electrode 22. As a forming method of the second insulation layer 42, the same forming method as that of the first insulation layer 32 can be used to form the second insulation layer 42, for example.

In step S23, the sealing film 62 is formed on the second insulation layer 42. As a material of the sealing film 62, a urethane-based material, a transparent resin such as polyvinyl alcohol, or synthetic rubber such as nitrile rubber can be given, as described before. As a forming method of the sealing film 62, a coating technique, a printing technique, or the like can be given. Through this, the opposing substrate 52 is completed.

Next, a method of bonding the element substrate 51 and the opposing substrate 52 together will be described with reference to FIG. 7 through FIG. 10I.

First, in step S31, as shown in FIG. 8B, the first seal member 14a is applied to the outer circumference of the frame separation wall 61 in the atmosphere. The material of the first seal member 14a is, for example, Kayatoron, which is a liquid epoxy resin having relatively high viscosity. The viscosity of the first seal member 14a is, for example, approximately 300 thousand Pa·s to 1 million Pa·s; it is preferable for the viscosity thereof to be 400 thousand Pa·s. The width of the first seal member 14a, when applied, is widened to an extent that the first seal member 14a can function in a vacuum, and is 150 μm, for example.

In step S32, as shown in FIG. 8C, the dispersion medium 15 that is formed of silicone oil including the electrophoretic particles 34 (white particles, black particles) is applied to the display region E on the element substrate 51. As an applying tool, a dispenser is used, for example. Further, a die coater or the like can also be used. The viscosity of the silicone oil is equal to or less than 10 cP, for example. The amount of the dispersion medium 15 is such that the dispersion medium 15 fills an interior space surrounded by the frame separation wall 61 when the element substrate 51 and the opposing substrate 52 are bonded together. The height of the frame separation wall 61 is, for example, 10 μm to 50 μm.

As described above, due to the narrow cell gap being 10 μm to 50 μm and due to the silicone oil being a low-viscosity solvent, the electrophoretic particles can migrate between the electrodes in equal to or less than 500 ms even at a temperature of approximately −30° C.

Because of the frame separation wall 61 being formed, it is possible to prevent the first seal member 14a from penetrating (spreading) into the display region E side. Further, the width of the first seal member 14a can be regulated so as not to extend beyond a predetermined width. Through this, it is possible to ensure the strength of the first seal member 14a.

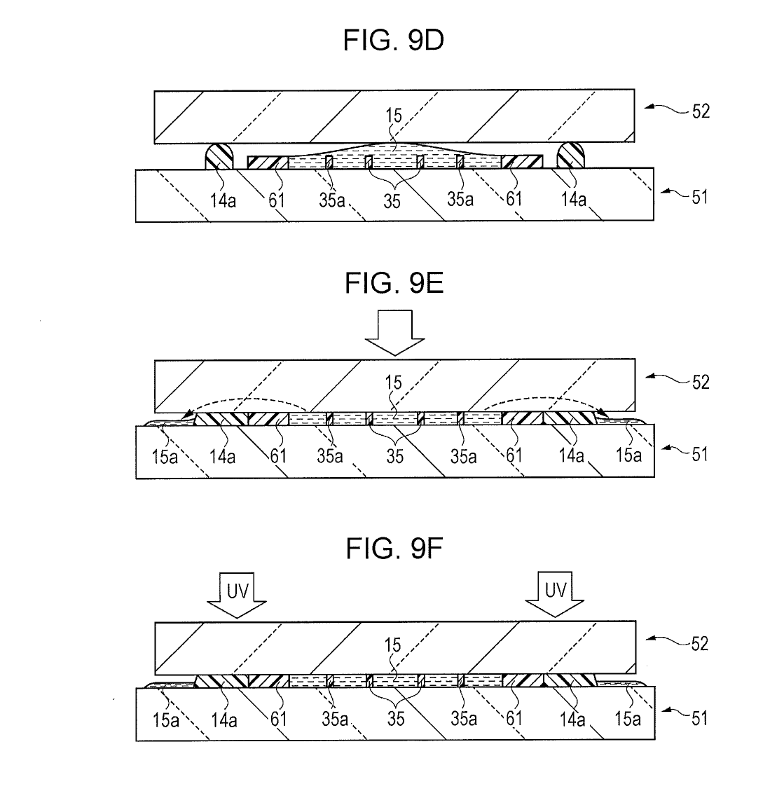

In step S33, as shown in FIG. 9D, it is started to bond the element substrate 51 and the opposing substrate 52 together. The bonding is carried out in a vacuum state in order to prevent air bubbles from entering into the cells 36. However, because silicone oil has a highly volatile property, a low vacuum state in which pressure is lower than the atmospheric pressure is prepared. The pressure is 500 Pa, for example.

In step S34, as shown in FIG. 9E, the dispersion medium 15 is sealed between the element substrate 51 and the opposing substrate 52. In other words, in the low vacuum state, the element substrate 51 and the opposing substrate 42 are bonded together with the first seal member 14a therebetween.

As the opposing substrate 52 is pressed toward the element substrate 51, the first seal member 14a is pressed down while the dispersion medium 15 is pushed toward the side of the frame separation wall 61 and the first seal member 14a so as to fill the space enclosed by the first seal member 14a. In the case where the applied amount of the dispersion medium 15 is larger in volume than the space enclosed by the first seal member 14a, the excess of the dispersion medium 15 spills over the first seal member 14a to flow out to the exterior.

In this case, the upper portion of the separation wall 35 disposed in the display region E penetrates into the sealing film 62 provided on the opposing substrate 52 side so that the dispersion medium 15 can be prevented from moving between the cells 36 adjacent to each other.

In step S35, as shown in FIG. 9F, in the case where the first seal member 14a is an ultraviolet curing resin, the first seal member 14a is hardened (bonded) by being irradiated with ultraviolet light. In the case where the first seal member 14a is a thermosetting resin, the first seal member 14a is heated to be hardened (bonded). The cell gap formed when the element substrate 51 and the opposing substrate 52 are bonded together is approximately 20 μm to 50 μm; in this embodiment, it is 30 μm.

The width of the first seal member 14a, when pressed down, is widened to an extent that the first seal member 14a can adhere even if the seal member makes contact with silicone oil as the dispersion medium 15, and is approximately 200 μm to 500 μm, for example; in this embodiment, it is 400 μm. In the case where the width of the first seal member 14a is 200 μm to 400 μm, it is possible to ensure the reliability of the sealing and obtain an electrophoretic device with a narrow frame region. Further, in the case where the width of the first sealing member 14a is 400 μm to 500 μm, a wider contact area with the opposing substrate 52 can be obtained, thereby making it possible to enhance the reliability of the sealing. Note that in the case where the width of the first seal member 14a is equal to or more than 500 it is considered that the seal member becomes uneven so that the bonding cannot be carried out efficiently. In the case where the width is equal to or less than 200 the force to bond the element substrate 51 and the opposing substrate 52 together is weakened due to the silicone oil penetrating between the first seal member 14a and the opposing substrate 52, thereby raising a risk that the reliability of the sealing cannot be ensured.

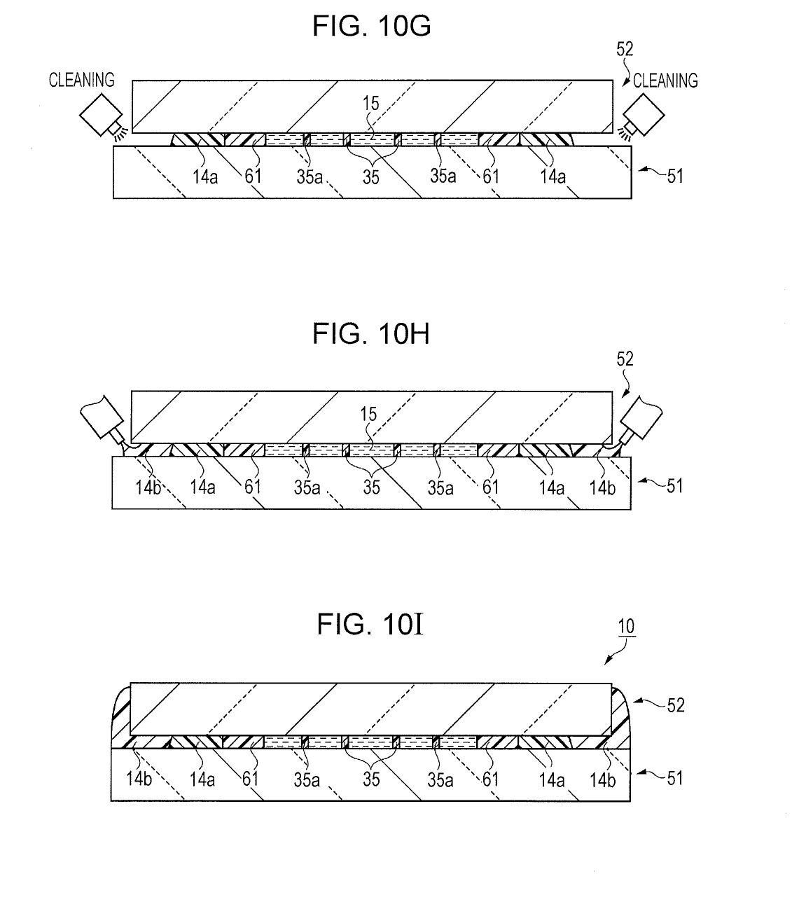

In step S36, as shown in FIG. 10G, a cleaning process is performed on the portions with which the second seal member 14b that is disposed for enhancing the bonding strength makes contact. More specifically, there is a risk that the silicone oil as the dispersion medium 15 may flow out or volatilize so as to adhere to the element substrate 51, the opposing substrate 52, the first seal member 14a, and the like. This causes the bonding strength of the interface to be decreased. Accordingly, it is advisable to perform the cleaning process at least on the portion that is in the vicinity of the outer circumference of the first seal member 14a and is on the electrophoretic layer 33 side of the element substrate 51, the electrophoretic layer 33 side of the opposing substrate 52, as well as the outer circumference side of the first seal member 14a.

As a cleaning agent, such an agent is preferable that does not dissolve the first seal member 14a; for example, Isopar, industrial gasoline, or the like can be given. By performing the cleaning process in the manner described above, it is possible to realize the interface where there exists little silicone oil (ideally speaking, there exists no silicon oil), thereby making it possible to enhance the bonding strength of the second seal member 14b. As a result, the reliability of the sealing can be enhanced.

In step S37, as shown in FIG. 10H, the second seal member 14b is formed and bonded to the outer circumference of the first seal member 14a in the atmosphere. More specifically, it is important for the second seal member 14b not to allow moisture to enter, to have relatively low viscosity, and to be inserted into the gap; the material thereof is, for example, acryl resin, epoxy resin, or the like. The viscosity of the second seal member 14b is, for example, 100 Pa·s to 500 Pa·s; it is preferable for the viscosity thereof to be 400 Pa·s. The width of the second seal member 14b is 400 μm, for example.

As a tool for applying the second seal member 14b, a dispenser, a die coater, or the like is used. As described above, the cleaning process is performed on the regions that make contact with the second seal member 14b (element substrate 51, opposing substrate 52, first seal member 14a). Accordingly, when the element substrate 51 and the opposing substrate 52 are bonded together, even if an excess of the dispersion medium 15 to be sealed spills over the first seal member 14a, the excess of the dispersion medium 15 that spills over the first seal member 14a is removed through the cleaning process, the bonding strength of the second seal member 14b can be enhanced.

Through this, as shown in FIG. 10I, the space sandwiched between the element substrate 51 and the opposing substrate 52 is sealed. Thereafter, the bonded entity is cut into a shape of product as needed so as to complete the electrophoretic device 10.

As described above in detail, according to the electrophoretic device 10, the manufacturing method for the electrophoretic device 10, and the electronic apparatus 100 of this embodiment, effects as follows can be obtained.

1. According to the electrophoretic device 10 of this embodiment, when the element substrate 51 and the opposing substrate 52 are bonded together, even if an excess of the dispersion medium 15 spills over the first seal member 14a or adheres to the first seal member 14a, the dispersion medium will be pushed out from between the first seal member 14a and the opposing substrate because the first seal member is provided using a high-viscosity material on the periphery of the electrophoretic layer 33. In addition, after the element substrate 51 and the opposing substrate 52 are bonded together, because the width of the first seal member 14a is sufficiently wide to be 200 μm to 500 μm, it is possible to bond and seal the element substrate 51 and the opposing substrate 52.

2. According to the electrophoretic device 10 of this embodiment, the first seal member 14a and the second seal member 14b are provided in series on the periphery of the electrophoretic layer 33. Accordingly, when the element substrate 51 and the opposing substrate 52 are bonded together, even if an excess of the dispersion medium 15 spills over the first seal member 14a to weaken the bonding strength of the first seal member 14a, the bonding strength can be enhanced by forming the second seal member 14b in a region where the dispersion medium 15 is removed through the cleaning process. Accordingly, it is possible to suppress the element substrate 51 and the opposing substrate 52 from being separated from each other and enhance the reliability of the sealing.

3. According to the electrophoretic device 10 of this embodiment, because the separation walls 35 for defining the plurality of cells 36 are provided in the display region E of the electrophoretic layer 33 sandwiched between the element substrate 51 and the opposing substrate 52, the cell gap between the element substrate 51 and the opposing substrate 52 can be determined based on the height of the separation walls 35. Further, because the frame separation wall 61 is provided between the display region E and the first seal member 14a, it is possible to prevent the first seal member 14a from penetrating into display region E side.

4. According to the electrophoretic device 10 of this embodiment, using silicone oil for the dispersion medium 15 makes it possible to cause the electrophoretic particles 34 included in the electrophoretic layer 33 to move even at low temperatures (for example, at a temperature of approximately −30° C.). This makes it possible to suppress the switching speed from being decreased. Further, because the surfaces of molecules of silicone oil are covered with a methyl group, the surface energy and the cohesion thereof are low, whereby the bonding strength of the seal member is decreased when the silicone oil adheres to the seal member. However, because the silicon oil, having high wettability, is not interposed in the portion that makes contact with the second seal member 14b, the strength of the second seal member 14b can be enhanced, thereby making it possible to enhance the reliability of the sealing.

5. According to the manufacturing method for the electrophoretic device 10 of this embodiment, the cleaning process is performed on the regions that make contact with the second seal member 14b (element substrate 51, opposing substrate 52, first seal member 14a). Accordingly, when the element substrate 51 and the opposing substrate 52 are bonded together, even if an excess of the dispersion medium 15 to be sealed spills over the first seal member 14a, it is possible to make the amount of the dispersion medium 15 remaining between the second seal member 14b and the opposing substrate extremely smaller than the amount of the dispersion medium 15 remaining between the first seal member 14a and the opposing substrate. Therefore, the strength of the second seal member 14b for bonding the element substrate 51 and the opposing substrate 52 together can be enhanced. As a result, it is possible to suppress the element substrate 51 and the opposing substrate 52 from being separated from each other.

6. According to the manufacturing method for the electrophoretic device 10 of this embodiment, because the frame separation wall 61 is formed surrounding the display region E, it is possible to prevent the dispersion medium 15 from flowing out with the frame separation wall 61 when the dispersion medium 15 is supplied to the display region E. This makes it possible to hold the dispersion medium 15 between the element substrate 51 and the opposing substrate 52. In addition, because the frame separation wall 61 is provided at the outside of the display region E in which the electrophoretic layer 33 is provided, it is also possible to prevent the first seal member 14a, which is formed later, from penetrating into the display region E side.

7. According to the electronic apparatus 100 of this embodiment, because the electrophoretic device 10 described above is included therein, it is possible to provide an electronic apparatus capable of enhancing reliability of the sealing.

The invention is not intended to be limited to the aforementioned embodiment, and many modifications can be made thereon without departing from the essential spirit of the invention as set forth in the appended aspects of the invention and the specification as a whole; entities derived from such modifications also fall within the technical scope of the invention. Several such modifications can be implemented in the following modes.

### First Variation

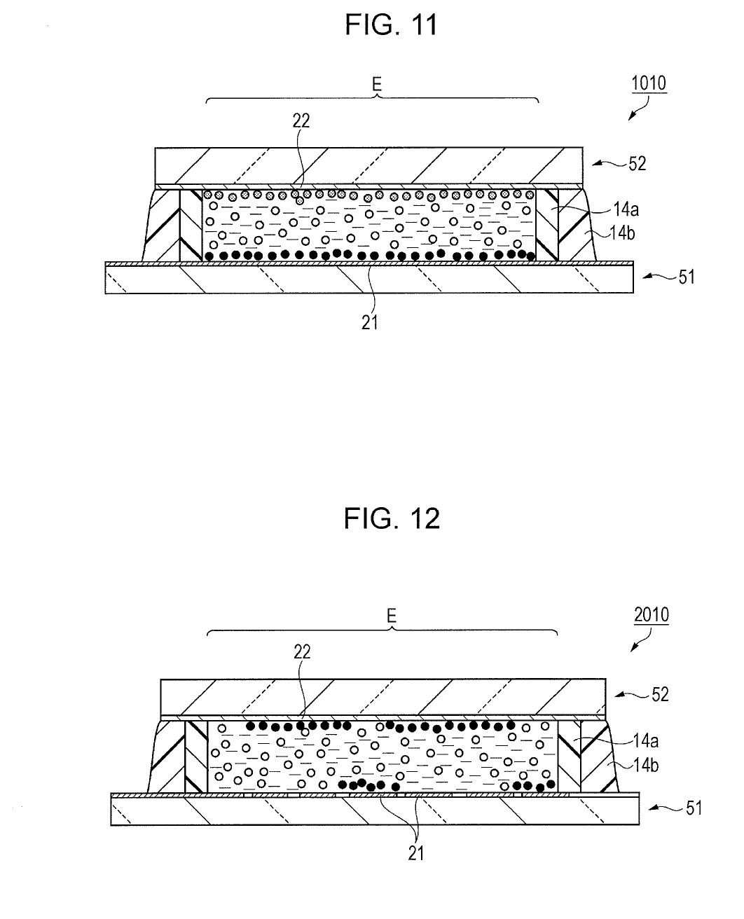

The invention is not limited to the aforementioned configuration in which the separation walls 35 and the frame separation wall 61 are provided between the element substrate 51 and the opposing substrate 52, and the configurations as shown in FIGS. 11 through 14 can be employed, for example. FIGS. 11 through 14 are schematic cross-sectional views illustrating the configurations of electrophoretic devices 1010, 2010, 3010, and 4010 as variations.

The electrophoretic device 1010, as shown in FIG. 11, has a configuration in which the separation walls 35 and the frame separation wall 61 are not provided. Like the above-described embodiment, the first seal member 14a and the second seal member 14b are provided on the periphery of the display region E. Further, only one pixel electrode 21 is disposed on the element substrate 51 side. Like the above embodiment, the common electrode 22 is disposed on the opposing substrate 52 side. In addition, by using color particles aside from the white particles and the black particles, color display can be given. Note that it is also possible to give color display in the above embodiment and the following variations by using the same color particles as those used in this variation. According to the electrophoretic device 1010 of the first variation, display of same color can be given across the entire surface of the display region E.

### Second Variation

Like the first variation, the electrophoretic device 2010, as shown in FIG. 12, has a configuration in which the separation walls 35 and the frame separation wall 61 are not provided. Like the above embodiment, the first seal member 14a and the second seal member 14b are provided on the periphery of the display region E. The plurality of pixel electrodes 21 are disposed on the element substrate 51 side. The opposing substrate 52 side is configured in the same manner as that of the above embodiment. According to the electrophoretic device 2010 of the second variation, text and images can be displayed.

### Third Variation

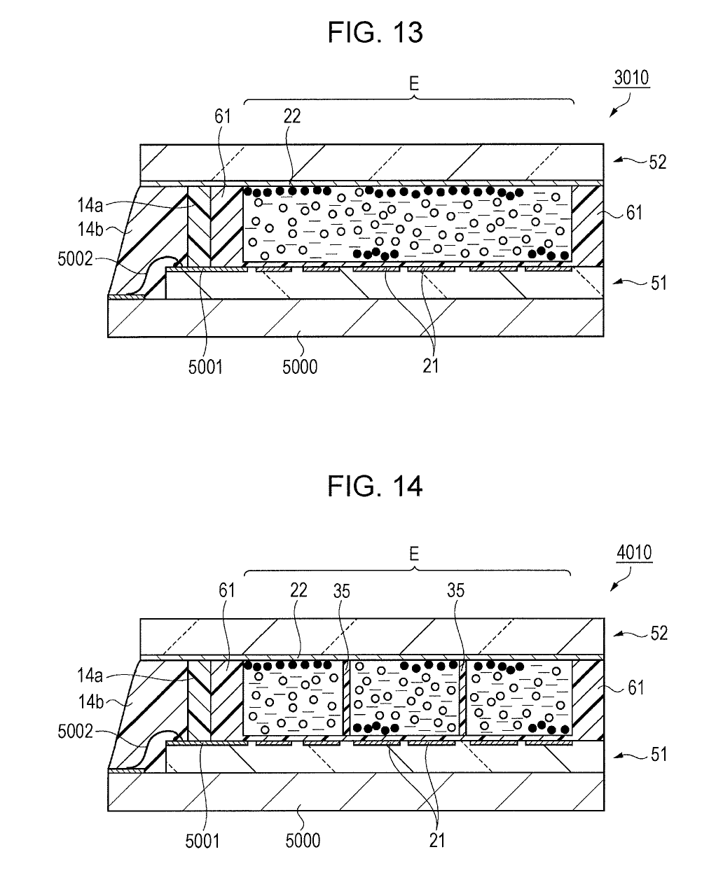

The electrophoretic device 3010, as shown in FIG. 13, has a configuration in which the separation walls 35 are not provided in the display region E. The configurations of the frame separation wall 61, the first seal member 14a, and the second seal member 14b are respectively the same as those of the above embodiment. The electrophoretic device 3010 of the third variation is configured to have a wiring substrate 5000. An external connection terminal 5001 provided on the element substrate 51 is electrically connected with the wiring substrate 5000 via bonding wire 5002. The second seal member 14b may be provided so as to cover a portion for the bonding wire 5002. According to the electrophoretic device 3010 of the third variation, it is possible to apply a voltage or send an image signal to the display region E using the wiring substrate 5000.

### Fourth Variation

The electrophoretic device 4010, as shown in FIG. 14, differs from the electrophoretic device 10 of the above embodiment in that the device of this variation includes the wiring substrate 5000. According to this variation, like the third variation, it is possible to apply a voltage or send an image signal to the display region E using the wiring substrate 5000. Further, since the separation walls 35 are disposed in the display region E, it is possible to make the cell gap between the element substrate 51 and the opposing substrate 52 uniform across the entirety of the display region E.

In the case where, like the electrophoretic devices 3010 and 4010 respectively discussed in the third variation and the fourth variation, the separation wall 35, the frame separation wall 61, or the like is provided, the device may be so configured as to include a residual film that remains when the separation wall 35 or the like is manufactured on the surface of the element substrate 51. To be more specific, in the case where the separation wall 35 is manufactured using a photolithography technique, the stated residual film remains as a result.

### Fifth Variation

The invention is not limited to manufacturing a single electrophoretic device 10 as described above, and a plurality of electrophoretic devices may be manufactured on a mother substrate (a wafer, a large-size substrate, or the like). In this case, size of such mother substrate is 400×500 mm, for example.

In the manufacture of the devices mentioned above, for example, the first seal member 14a is formed so as to surround an active area on a mother substrate at the element substrate side using a dispenser. Then, the dispersion medium 15 is supplied to the area surrounded by the first seal member 14a. Thereafter, a mother substrate at the opposing substrate side is mounted and bonded to the mother substrate at the element substrate side. Next, scribe lines are formed so as to divide the bonded entity into a plurality of pieces. Then, the second seal member 14b is applied to each piece of the electrophoretic devices. The removal of an excess of the dispersion medium 15 that overflowed when the two mother substrates were bonded to each other is carried out before the pieces of the electrophoretic devices are produced, for example. With this, the plurality of electrophoretic devices 10 can be manufactured in large quantities in the same manufacturing process.

### Sixth Variation

The invention is not limited to the aforementioned configuration in which the separation walls 35, the frame separation wall 61, and the like are disposed on the element substrate 51 side, and the separation walls 35, the frame separation wall 61, and the like may be disposed on the opposing substrate 52 side.

### Seventh Variation

The above-described cells 36 enclosed by the separation walls 35 are formed in a grid pattern when viewed from above. However, the invention is not limited thereto, and the cells 36 may be each formed in a honeycomb shape (hexagon), for example. Note that the cells 36 are not limited to being formed in a grid or honeycomb shape, and may be formed in other shapes such as a polygon, a circle, a triangle, and so on.

### Eighth Variation

The invention is not limited to use of the aforementioned photolithography technique to form the separation walls 35, and may be used are printing processes such as nanoimprinting, screen printing, relief printing, gravure printing, and so on for the formation of the separation walls 35.

### Ninth Variation

As described above, it is only necessary for the first substrate member 31 and the second substrate member 41 to use a light-transmissive material at the display side, and a plastic substrate may be used aside from a glass substrate.

The entire disclosure of Japanese Patent Application No. 2013-144264, filed Jul. 10, 2013 is expressly incorporated by reference herein.

What is claimed is:

1. An electrophoretic device comprising:
a first substrate;
a second substrate that is disposed opposing the first substrate;
an electrophoretic layer including a dispersion medium in which at least one or more electrophoretic particles are dispersed; and
a first seal member that is disposed surrounding the electrophoretic layer and bonds the first substrate and the second substrate together,
wherein width of the first seal member is no less than 200 μm and no more than 500 μm.

2. The electrophoretic device according to claim 1, further comprising:
a second seal member that is disposed at the outer side of the first seal member and bonds the first substrate and the second substrate together,
wherein an amount of the dispersion medium remaining between the second seal member and the second substrate is less than an amount of the dispersion medium remaining between the first seal member and the second substrate.

3. The electrophoretic device according to claim 1,
wherein the electrophoretic layer is partitioned into a plurality of cells by separation wall disposed in a display region between the first substrate and the second substrate.

4. The electrophoretic device according to claim 1,
wherein a frame wall is disposed between the electrophoretic layer and the first seal member.

5. The electrophoretic device according to claim 4,
wherein the frame wall is disposed in contact with the first seal member.

6. The electrophoretic device according to claim 4,
wherein height of the frame wall is 10 μm to 50 μm, and
a distance from the display region to respective end surfaces of the first substrate and the second substrate is equal to or less than 1 mm.

7. The electrophoretic device according to claim 4,
wherein the separation wall and the frame wall are made of the same material.

8. The electrophoretic device according to claim 1,
wherein the dispersion medium is silicone oil.

9. The electrophoretic device according to claim 1,
wherein viscosity of the dispersion medium is equal to or less than 10 cP.

10. The electrophoretic device according to claim 1,
wherein the electrophoretic layer include white particle, black particle, and the dispersion medium,
a weight percentage of the white particle to a total weight of the white particle, the black particle, and the dispersion medium is equal to or less than 30%, and
a weight percentage of the black particle to the above total weight is equal to or less than 10%.

11. The electrophoretic device according to claim 3,
wherein a sealing film is provided between the electrophoretic layer and the second substrate and between the separation wall and the second substrate.

12. A manufacturing method for an electrophoretic device comprising:
applying a first seal member on a periphery of a display region on a first substrate,
supplying the display region with a dispersion medium including electrophoretic particle, and
bonding the first substrate to a second substrate that is disposed opposing the first substrate with the first seal member interposed between the first and second substrates under a lower pressure than atmospheric pressure so that a width of the first seal member is no less than 200 μm and no more than 500 μm after the bonding.

13. The manufacturing method for the electrophoretic device according to claim 12, further comprising:
removing at least the dispersion medium adhering to regions that each make contact with a second seal member to be formed on the periphery of the first seal member; and
forming the second seal member on the periphery of the first seal member.

14. The manufacturing method for the electrophoretic device according to claim 12, furthermore comprising:
forming separation wall for defining a plurality of cells in the display region on the first substrate before the applying of the first seal member.

15. The manufacturing method for the electrophoretic device according to claim 12, still further comprising:
forming a frame wall on the first substrate before the applying of the first seal member.

16. The manufacturing method for the electrophoretic device according to claim 12,
wherein viscosity of the first seal member is 300 thousand Pa·s to 1 million Pa·s, and
viscosity of the second seal member is 100 Pa·s to 500 Pa·s.

17. The manufacturing method for the electrophoretic device according to claim 12,
wherein the dispersion medium is silicone oil.

18. An electronic apparatus comprising the electrophoretic device according to claim 1.

19. An electronic apparatus comprising the electrophoretic device according to claim 2.

20. An electronic apparatus comprising the electrophoretic device according to claim 3.
